(19) United States
(12) Patent Application Publication
(10) Pub. No.: US 2023/0334015 A1
(43) Pub. Date: Oct. 19, 2023

(54) Systems and Methods for Sending Notes to Electronic Folders using Metadata Tags

(71) Applicant: PERSILE INC, HOOPER, UT (US)

(72) Inventor: Randon Christian Young, Hooper, UT (US)

(21) Appl. No.: 18/301,046

(22) Filed: Apr. 14, 2023

Related U.S. Application Data
(60) Provisional application No. 63/330,834, filed on Apr. 14, 2022.

(51) Int. Cl. G06F 16/14; H04L 51/08; H04L 51/21

(52) U.S. Cl. CPC G06F 16/14; H04L 51/08; H04L 51/21

(57) ABSTRACT

A technology is described for sending notes to user-folders using metadata tags. An example of the technology may include the operations of receiving data messages from a plurality of user devices sent over a messaging network, where the data messages are addressed to a common telephone number that is associated with a note management system, and the data messages contain at least a metadata tag and a note. Identifying a user account associated with a source address of a data message in response to receiving the data message from a user device. Analyzing the data message to identify a metadata tag and a note contained in the data message, where the metadata tag indicates a user-folder to store the note, and storing the note in the user-folder associated with the user account.

### PRIORITY CLAIM

This application claims priority to the provisional patent application Ser. No. 63/330,834 titled “Systems and Methods for Sending Notes to Electronic Folders using Metadata Tags” filed on Apr. 14, 2022, which is incorporated by reference in its entirety.

### BACKGROUND

Note-taking is the practice of recording information from different sources and platforms. By taking notes, the writer records the essence of the information, freeing their mind from having to recall some or all of the information. Notes are commonly drawn from a transient source, such as an oral discussion at a meeting, or a lecture (notes of a meeting are usually called minutes), in which case the notes may be the only record of the event. In the past, a user may have jotted down a note on a sticky pad or typed notes using word processing software. However, users may be unable to locate the sticky note or electronic document when needed. Note-taking software has attempted to address these issues by allowing users to make short notes for later retrieval and reference. However, the note-taking software has fallen short in many areas, such as allowing a user to capture an idea quickly and store the note without having to navigate the menus, functions, directories, and folders of the note-taking software.

### BRIEF DESCRIPTION OF THE DRAWINGS

FIGS. 1A and 1B are diagrams illustrating examples of sending a note from a user device to a user-folder using a note management system interface.

FIG. 2 is a block diagram that illustrates various example components included in a system for filing notes using metadata tags.

FIG. 3 is a diagram illustrating an example of storing an attachment included with a data message in a user-folder indicated by a metadata tag.

FIG. 4 is a diagram illustrating an example of storing a note to a sub-folder.

FIG. 5 is a flow diagram that illustrates an example control flow and associated architecture of a system on which the present technology can be implemented.

FIG. 6 is a flow diagram illustrating an example method for filing notes using metadata tags.

FIG. 7 is a block diagram illustrating an example of a computing device that may be used to execute the methods described herein.

### DETAILED DESCRIPTION

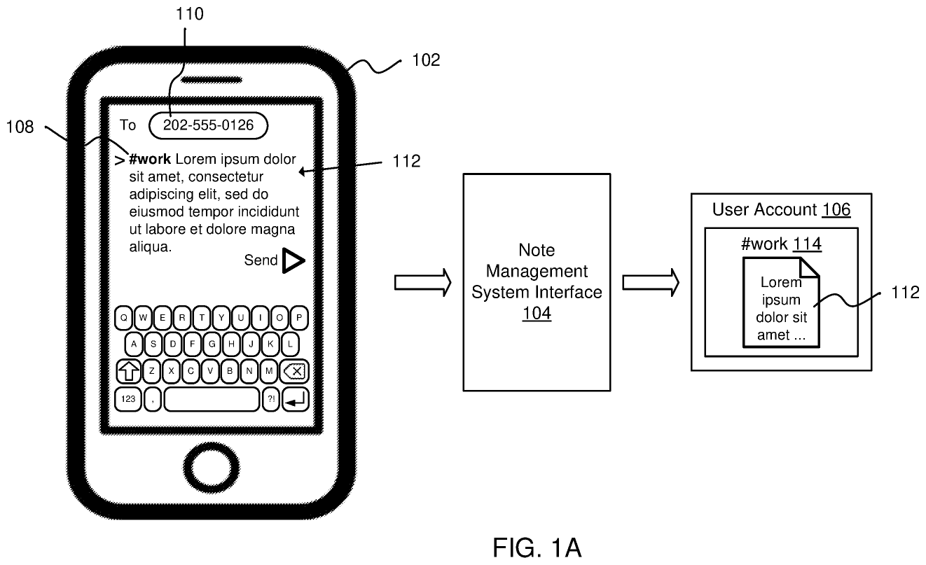

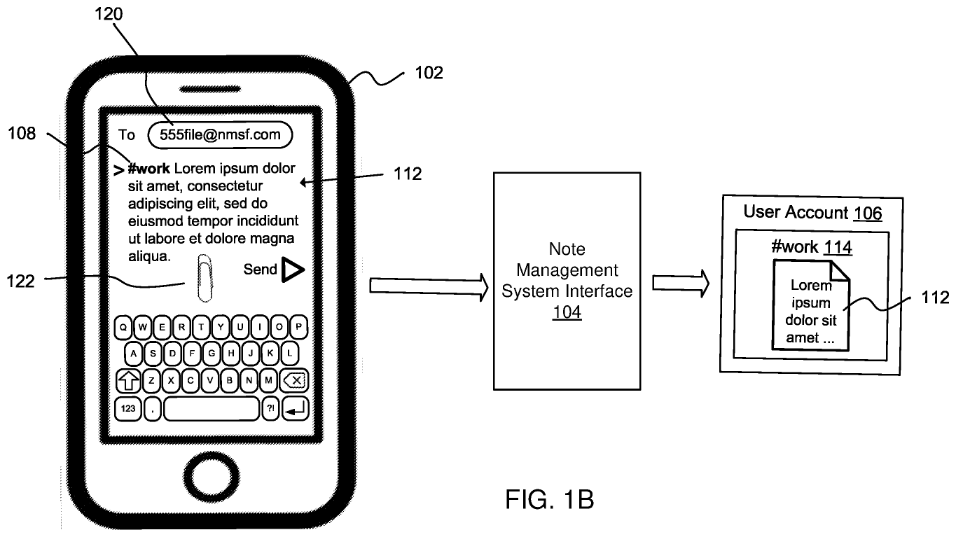

Technologies are described for sending an electronic note from a user device, such as a mobile device, to an electronic file folder located on a remote server using a messaging network and a metadata tag. A note management system may enable users to send notes from their user devices over a messaging network to be stored in user-files managed by the note management system. In order to describe the technologies, the following examples are provided with reference to the figures. FIG. 1 is a diagram illustrating a high-level example of sending a note 112 from a user device 102, such as a mobile device, to a user-folder 114 via a note management system interface 104 (e.g., an application programming interface (API)) for the note management system, which is described in more detail later in association with FIG. 2. In one example, the note management system can receive data messages sent from user devices 102 over a messaging network, wherein the data messages can be addressed to a common telephone number 110 that is associated with the note management system. The data messages can contain a note 112 and one or more metadata tags 108 indicating a user-folder 114 (e.g., a file folder) or user-directory in which to store the note 112. As a non-limiting example, a user can utilize a messaging application (e.g., SMS and/or MMS application, instant messaging application, in-app messaging, etc.) or service to compose a data message that includes a note 112 (e.g., a brief record of facts, topics, or thoughts, as an aid to memory). The user can include a metadata tag 108 (e.g., a hashtag) in the data message that, for example, precedes or follows the note 112 to indicate a user-folder 114 managed by the note management system in which to store the note 112. The user can save the note 112 to the user-folder 114 by sending the data message (e.g., text messaging or texting) to the note management system interface 104 using the common telephone number 110 associated with the note management system. The note 112 may also be a task the user wants to store in the user-folder 114, so that the user may perform that task at a later point in time. In addition, the notes or tasks may contain: images (e.g., .jpg, .gif, etc.), links, documents, voice notes, emoji's, or any other type of data object as an attachment.

In response to receiving the data message from the user device 102, the note management system can identify a user account 106 associated with a source messaging address (e.g., a user's phone number) associated with the data message and identify user-folders or user-directories that are connected to the user account 106. The note management system can analyze the data message to identify the note 112 and the metadata tag 108 contained in the data message. For example, the note management system can parse the data message to identify the metadata tag 108 and identify the note 112, which, for example, can precede or follow the metadata tag 108 in the data message. The metadata tag 108 contained in the data message can indicate a user-folder 114 managed by the note management system to store the note 112. Thereafter, the note management system can store the note 112 in the user-folder 114 indicated by the metadata tag 108 and associated with the user account 106. In one example, a data message can include attachments (not shown) and the note management system can store the attachments to a user-folder indicated by a metadata tag contained in the data message. Also, in one example, metadata tags included in a data message can indicate a sub-folder or sub-directory in which to store a note and/or attachments.

In another example, FIG. 1B illustrates sending a note 112 in email form from a user device 102, such as a mobile device, to a user-folder 114 via a note management system interface 104. In one example, the note management system can receive email messages sent from user devices 102 over a messaging network (e.g., TCP/IP), wherein the email messages can be addressed to a common email address 120 or an email address setup up for a specific user that is associated with the note management system. The data messages can contain a note 112 and one or more metadata tags 108 indicating a user-folder 114 (e.g., a file folder) or user-directory in which to store the note 112. As an example, a user can utilize an email application or service to compose an email that includes a note 112. The user can include a metadata tag 108 (e.g., a hashtag) in the data message that, for example, precedes or follows the email to indicate a user-folder 114 managed by the note management system in which to store the note 112. The user can save the note 112 to the user-folder 114 by sending the email to the note management system interface 104 using the email 120 associated with the note management system.

In response to receiving the data message from the user device 102, the note management system can identify a user account 106 associated with a source messaging address (e.g., a user's email) associated with the data message and identify user-folders or user-directories that are connected to the user account 106. The note management system can analyze the data message to identify the note 112 and the metadata tag 108 contained in the data message. For example, the note management system can parse the data message to identify the metadata tag 108 and identify the note 112, which, for example, can precede or follow the metadata tag 108 in the data message. The metadata tag 108 contained in the data message can indicate a user-folder 114 managed by the note management system to store the note 112. Thereafter, the note management system can store the note 112 in the user-folder 114 indicated by the metadata tag 108 and associated with the user account 106. In one example, an email can include attachments 122 and the note management system can store the attachments to a user-folder indicated by a metadata tag contained in the data message.

The present system can be used for personal use, business use or any other use. In addition, the system may be used with automated messaging from machine to machine, from a machine to a human or from a human to an automated machine such as an Internet of Things (IoT) machine. In another example, the messaging processes can integrate with existing software such as customer relationship management (CRM) so that the users can text or email a system with a hashtag and can create folders, enter notes, and file those notes into the existing CRM system. This may be a benefit to salesman who need to record their notes as they walk out of calls with their customers without having to login to the CRM system.

FIG. 2 illustrates components of an example system environment 200 on which the present technology may be executed. The system environment 200 may include one or more server computers 202 that host a note management system and a number of user devices 220a-n that communicate with the note management system via a messaging network 218. The server computers may be in a private cloud, public cloud or in a private data center. As shown, the server computer(s) 202 can include a note management system-interface 204, a user account module 206, a note storage module 208, a note retrieval module 210, and other modules, services and/or interfaces. Also, the server computer(s) 202 can host various data stores 212 containing user account information and user-files 216.

A user device 220a-n can be used to compose and send notes to the server computer(s) 202 for storage in a data store 212. A note can be composed using a messaging application 222, such as a text messaging or texting application that utilizes short message service (SMS) and/or multimedia messaging service (MMS) to send a data message over a messaging network 218, which can include a traditional circuit-switched telephone network (PSTN), a data switched network (e.g., VOIP), or a TCP/IP network (e.g., the Internet). A messaging application 222 used to compose a note can also include other types of text-based applications (e.g., instant messaging, social media messaging, email, and the like) that send data messages over the Internet, intranet, wide area network (WAN), local area network (LAN) and other types of computing networks. Also, a messaging application 222 can include an in-app messaging feature used to compose a note as an in-app message which can be sent to the note management system. In-app messages may be messages that are composed/received directly in an active mobile application. In one example, a messaging application 222 can be used to compose a note containing calendaring/event scheduling information, and the note can be sent to the note management system which can be configured to create an event using the calendaring/event scheduling information. In another example, a messaging application 222 can be used to attach a file to a data message which can be sent to the server computer(s) 202 and stored in a data store 212.

The system environment 200 can accommodate multiple user devices 220a-n (e.g., tens of hundreds, thousands, or millions of user devices 220a-n) that are associated with user accounts 214 of the note management system hosted on the server computer(s) 202. The note management system may be integrated with dedicated note taking software, CRM software, a messaging application, a text posting application, a video posting application, a social media platform, a web application, or another type of application. A user device 220a-n can include any computing device capable of sending and receiving data over a messaging network 218. A user device 220a-n can be a device such as, but not limited to, a mobile device, a desktop computer, a laptop or notebook computer, a tablet computer, a network computer, or other devices with like capability. The messaging network 218 can include any network technology, including a PTSN, an intranet, the Internet, a LAN, a WAN, a wireless data network, or any other such network or combination thereof. Components utilized for such a system may depend at least in part upon the type of network and/or environment selected. Communication over the messaging network 218 may be enabled by wired or wireless connections and combinations thereof.

As described above, the note management system hosted on the server computer(s) 202 can include a note management system-interface 204 that allows user devices 220a-n to communicate with the note management system. In one example, the note management system-interface 204 can be an API that includes a set of definitions and a protocol for managing user accounts 214, user-folders 216, and notes stored in the data store 212. For example, the note management system-interface 204 can include API definitions for account management actions, note storage actions, note retrieval actions, and other actions. An action can be performed by a software module or service configured to perform the action.

### Account Management

Actions associated with managing a user account 214 can be performed by the user account module 206. For example, a user of the note management system can create and manage a user account 214 that allows the user to send notes to the note management system and retrieve the notes from the note management system. The account module 206 can be configured to create a new user account 214 in response to a request from a user, via a user device 220a-n. In one example, the note management system interface 204 can receive requests from user devices 220a-n to create new user accounts and provide the request to the user account module 206. In response, the user account module can create a user account 214 that includes an account number and a source address (e.g., a user's phone number, international mobile equipment identity (IMEI) number, internet protocol (IP) address, media access control (MAC) address, or another identifier) which can be used to identify a data message as being associated with the user account. More specifically, a messaging application 222 can include the source address in a data message, and as described in more detail below, the source address can be used to identify the data message as coming from a user device 220a-n associated with the user account 214.

In one example, the account module 206 can perform actions associated with managing user accounts 214 by updating and deleting user accounts 214 in response to user requests. For example, users via user devices 220a-n can send requests to the note management system interface 204 requesting to update or delete user accounts 214. In response, the note management system interface 204 can provide the requests to the user account module 206 which performs the requested action, such as update a user account 214 (e.g., add an additional source address for a new user device 220a-n, delete a source address for a user device 220a-n no longer used by a user, etc.) or delete the user account 214.

In one example, the account module 206 can be configured to identify a user account 214 associated with a source address of a data message received at the note management system. In one example, the note management system interface 204 can receive data messages along with requests from user devices 220a-n to store notes in user-folders 216 associated with user accounts 214. In response to a request, the note management system interface 204 can provide the data message to the user account module 206, and the user account module 206 can extract a source address from the data message and identify a user account 214 associated with the source address. As a non-limiting example, the user account module 206 can extract a user's phone number from a data message and query the user accounts 214 in the data store 212 using the phone number to identify a user account 214 that is associated with the phone number.

### Note Storage

Actions associated with storing notes using the note management system hosted on the server computer(s) 202 can be performed by the note storage module 208. User devices 220a-n can send data messages containing metadata tags and note content to the note management system interface 204 along with a request to store the note content in the note management system. In response, the note management system interface 204 can provide the data messages to the note storage module 208. The note storage module 208 can analyze a data message to identify a user account 214 associated with the data message, identify one or more metadata tags and note content contained in the data message, and store the note content to a user-folder 216 that has a folder-name that corresponds to the metadata tag. For example, the note storage module 208 can identify the user account 214 associated with the data message by analyzing the data message (e.g., a header of the data message) to identify a source address of the data message. The source address can be a user's phone number, IMEI number, IP address, MAC address, or another identifier that can be used to associate the data message with a user and/or a user device 220a-n. The note storage module 208 can send the source address to the user account module 206 (e.g., via a method, function, or API call), and the user account module 206 can query the user accounts 214 to identify an account number linked to the source address and return the account number to the note storage module 208.

The note storage module 208 can identify one or more metadata tags and note content in the data message by analyzing the message body to identify the metadata tag(s) and note content contained in the data message. In one example, a metadata tag can indicate a beginning of note content. The note storage module 208 can identify a metadata tag contained in the body of a data message and classify content following the metadata tag as note content. In another example, a metadata tag can indicate an end of a note. The note storage module 208 can analyze the message body to identify a metadata tag and classify text preceding the metadata tag as note content. In at least one example, a data message can contain multiple notes where one or more metadata tags can be used to delimit the beginning and/or end of each note contained in the data message. A metadata tag contained in a data message can be a keyword or term that both identifies note content in the body of a data message and indicates the name of a user-folder 216 to store the note content. In one example, a symbol can preface a folder name in a metadata tag. For example, a hash symbol (“#”), asterisk symbol (“*”) or any pre-defined symbol in the messaging application can preface a folder name in a metadata tag.

In one example, multiple entries or tasks can be included in a note using a symbol (e.g., an asterisk) to separate each entry/task in the note. As an illustration, a note can be composed to include a metadata tag followed by a first entry, a symbol, and a second entry (e.g., #Goals Lose 20 lbs*Go to the grocery store*Read 20 minutes). The note storage module 208 can analyze a data message containing the note to identify the metadata tag and symbol separating the entries, and the note storage module 208 can break out each entry into separate line items/notes stored in folder indicated by the metadata tag. As an illustration based on the above, the note storage module 208 would store three separate note entries “Lose 20 lbs”, “Go to the grocery store”, and “Read 20 minutes” in a folder named “Goals”.

After identifying the metadata tag(s), note content, and obtaining the account number for the user account 214, the note storage module 208 can use the account number to identify a user-folder 216 owned by the user account 214 and has a folder name that corresponds to a metadata tag contained in the data message. In the event that the user-folder 216 does not exist, the note storage module 208 can create a new user-folder 216 owned by the user account 214 and assign a name to the new user-folder 216 that corresponds to the metadata tag. As an illustration, assuming that the metadata tag included in the data message is “#work”, the note storage module 208 can create and name a user-folder named “#work”. In one example, after creating a new folder, a user can designate the folder as a note folder or a task folder. Folders designated as task folders can contain task metadata shown as check boxes associated with task entries contained in the task folder, and the task metadata can be updated to show a marked check box indicating an associated task has been completed.

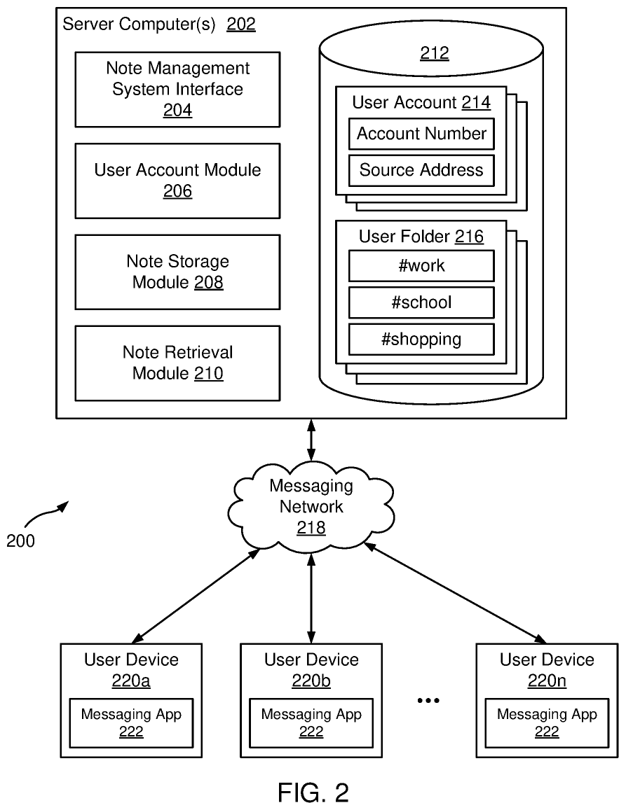

After identifying or creating the user-folder 216 having a folder name that corresponds to the metadata tag, the note storage module 208 can store the note in the user-folder 216. In the case that a data message includes an attachment, such as a media file, document, etc., the note storage module 208 can store the attachment in the user-folder 216. FIG. 3 illustrates one example of storing an attachment 306 included with a data message 304 in a user-folder 316. The note management system 302 analyzes the data message 304 and determines based on the metadata tag “#receipts” to store the attachment 306 in the folder “#receipts” in the user-folders 316.

In one example configuration, notes and/or attachments can be stored in sub-folders having names that correspond to metadata tags contained in data messages. As one example, the note storage module 208 can analyze a data message to identify a first metadata tag that indicates a parent folder and a second metadata tag that indicates a child folder in which to store the note.

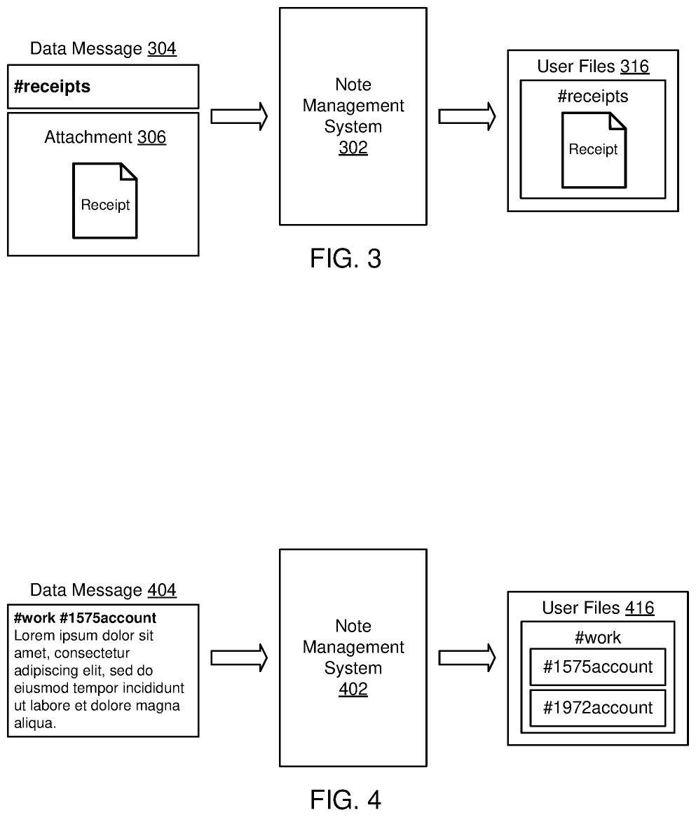

FIG. 4 illustrates one example of storing a note to a sub-folder, where a data message 404 containing a note prefaced by a first metadata tag “#work” indicating a parent folder and a second metadata tag “#1575account” indicating a sub-folder. The note management system 402 analyzes the data message 404 and determines based on the metadata tags to store the note in the sub-folder “#1575account” of the user-files 416.

### Note Retrieval

Referring again to FIG. 2, actions associated with retrieving notes from the note management system hosted on the server computer(s) 202 can be performed by the note retrieval module 210. User devices 220a-n request notes stored in the note management system by sending requests to the note management system interface 204. In response, the note management system interface 204 can provide the request to the note retrieval module 210, which can obtain an account number for a user account 214 associated with the request and query user-folders 216 associated with the account number to identify the note being requested. In one example, the user-folders 216 can be presented in a graphical user interface (GUI) and the user can browse the user-folders 216 for user-folders and/or notes they may want to retrieve and view on a device 220a-n. The note retrieval module 210 can provide the note to the note management system interface 204, which can provide the note to a user device 220a-n that requested the note.

The various processes and/or other functionality contained within the system environment 200 may be executed on one or more processors that are in communication with one or more memory modules. In one example, the system environment 200 may include a number of computing devices that are arranged, for example, in one or more server banks or computer banks, or other arrangements. The computing devices may support a computing environment (e.g., cloud computing environment) using hypervisors, virtual machine monitors (VMMs) and other virtualization software.

The term “data store” may refer to any device or combination of devices capable of storing, accessing, organizing and/or retrieving data, which may include any combination and number of data servers, relational databases, object oriented databases, cluster storage systems, data storage devices, data warehouses, flat files and data storage configuration in any centralized, distributed, or clustered environment. The storage system components of the data store may include storage systems such as a SAN (Storage Area Network), cloud storage network, volatile or non-volatile RAM, optical media, or hard-drive type media. The data store may be representative of a plurality of data stores as can be appreciated.

API calls, procedure calls or other network commands that may be made in relation to the modules and services included in the system environment 200 may be implemented according to different technologies, including, but not limited to, Representational state transfer (REST) technology or Simple Object Access Protocol (SOAP) technology. REST is an architectural style for distributed hypermedia systems. A RESTful API (which may also be referred to as a RESTful web service) is a web service API implemented using HTTP and REST technology. SOAP is a protocol for exchanging information in the context of Web-based services.

FIG. 2 illustrates that certain processing modules may be discussed in connection with this technology and these processing modules, in one example, can be implemented as computing services. For example, a module may be considered a service with one or more processes executing on a server or other computer hardware. Such services may be centrally hosted functionality or a service application that may receive requests and provide output to other services or consumer devices. Modules providing services may be considered on-demand computing that are hosted in a server, a virtualized service environment, and/or a grid or cluster computing system. An API may be provided for each module to enable a second module to send requests to and receive output from the first module. Such APIs may also allow third parties to interface with the module and make requests and receive output from the modules. While FIG. 2 illustrates an example of a system environment that may implement the techniques above, many other similar or different environments are possible. The example system environments discussed and illustrated above are merely representative and not limiting.

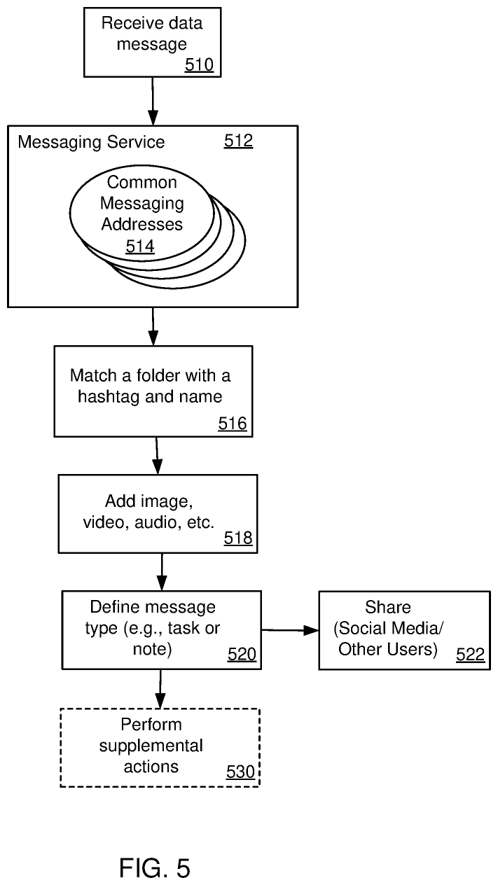

FIG. 5 is a flow diagram that illustrates an example control flow and associated architecture of a system on which the present technology can be implemented. As shown, the system can include a control flow for storage actions, and a control flow for note filing actions. In particular, FIG. 5 shows that note filing actions can include receiving a data message 510 (e.g., text message, email, instant message, etc.) sent to a common messaging address 514 (e.g., phone number, email address, handle), wherein the data message contains a metadata tag (e.g., hashtag) and a note, and the metadata tag indicates a folder in which to store the note. In one example, the metadata tag can comprise a hash symbol or another defining metadata tag that prefaces a folder name (e.g., #example_folder_name, *example_folder2, /*example3, \hat{ }example4, etc.). The system can recognize a user account associated with the data message via a source address (e.g., user phone number, email, instant messaging handle, etc.) of the data message.

A folder may be identified that matches 516 the folder name following the metadata tag, if the folder has already been created. Then the text of the note or task may be stored into the folder. If a folder does not exist that matches the folder name, a new folder may be created and then storage of the note or digital objects may occur. An attachment may also be stored into a folder 518 such as an image, photo, video, audio, document, or other digital objects associated with the data message. A message type may also be defined 520 for the data message when such data is provided with the data message. The message type may help define other actions or operations that are performed when the data message is received or the detection of specific digital object types may activate other operations. For example, in addition to storing the note in a folder indicated by the metadata tag, the system can perform a number of other optional, supplemental actions 530, such as, create an event associated with the note, share the note folder with other users, create a sub-folder and store the note in the sub-folder, generate a calendar event associated with the note, set a reminder associated with the note, mark a task associated with the note as a priority, create a social media post based on the note, and/or store an attachment received with the note in the folder indicated by the metadata tag. As will be appreciated, the actions listed above are not a comprehensive list of actions that can be performed by the system. Once the data message has been processed and stored, the stored results in the folder may be shared 522 with other users of the system or through social media channels (e.g., Facebook, LinkedIn, Snapchat, Instagram, YouTube, and similar services).

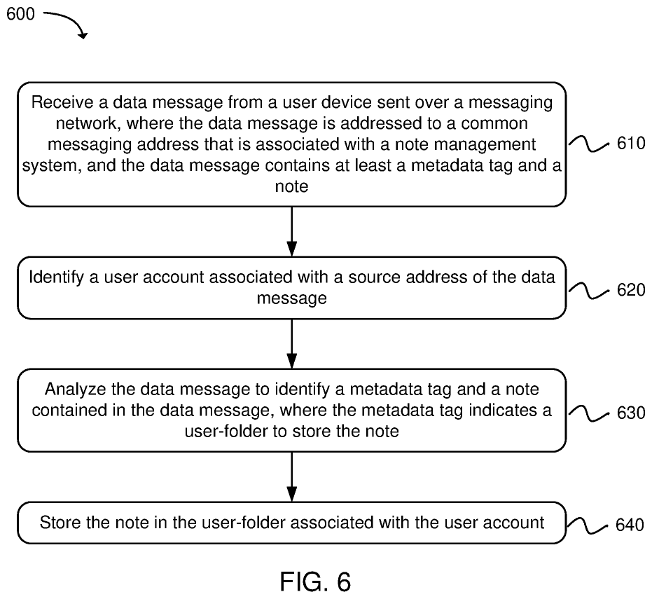

FIG. 6 is a flow diagram illustrating an example method 600 for filing notes using metadata tags. As in block 610, data messages can be received from a plurality of user devices sent over a messaging network. The data messages can be addressed to a common messaging address that is associated with a note management system, and the data messages can contain at least a metadata tag and a note. In one example, the metadata tag can include a hash symbol that prefaces a folder name.

As in block 620, in response to receiving a data message from one of the user devices, the note management system can identify a user account associated with a source address of the data message. The source address of the data message can be one of: a phone number of the user, a unique hardware identifier of the user device, internet protocol (IP) address, an account number associated with the user, or another identifier. In one example, the note management system can determine that a user-folder associated with a user account does not exist and create the user-folder associated with the user account. As part of creating the user-folder, the note management system can assign the name of the metadata tag to the newly created user-folder.

As in block 630, the note management system can analyze the data message to identify a metadata tag and a note contained in the data message. The metadata tag can indicate a user-folder in which to store the note. In one example, the metadata tag can indicate a beginning of the note in the data message, or the metadata tag can indicate an end of the note in the data message.

In one example, the note management system can analyze the data message to identify a first metadata tag that indicates a parent folder and a second metadata tag that indicates a child folder in which to store the note. Also, in one example, the note management system can receive a file or data object attached to the data message and store the file or data object in the user-folder.

As in block 640, the note management system can store the note in the user-folder associated with the user account.

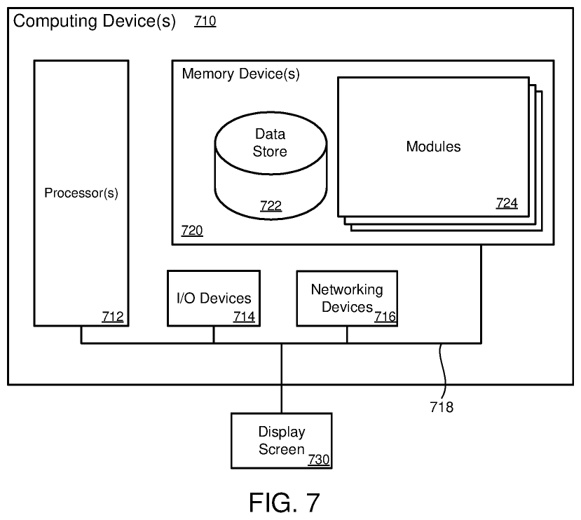

FIG. 7 illustrates a computing device 710 which may execute the foregoing subsystems of this technology. The computing device 710 and the components of the computing device 710 described herein may correspond to the servers and/or client devices described above. The computing device 710 is illustrated on which a high-level example of the technology may be executed. The computing device 710 may include one or more processors 712 that are in communication with memory devices 720. The computing device may include a local communication interface 718 for the components in the computing device. For example, the local communication interface may be a local data bus and/or any related address or control busses as may be desired.

The memory device 720 may contain modules 724 that are executable by the processor(s) 712 and data for the modules 724. In one example, the modules 720 may include an IFE system module, a user interface module, a video service subsystem module, a passenger profile subsystem module, and other modules. The modules 724 may execute the functions described earlier. A data store 722 may also be located in the memory device 720 for storing data related to the modules 724 and other applications along with an operating system that is executable by the processor(s) 712.

Other applications may also be stored in the memory device 720 and may be executable by the processor(s) 712. Components or modules discussed in this description that may be implemented in the form of software using high programming level languages that are compiled, interpreted or executed using a hybrid of the methods.

The computing device may also have access to I/O (input/output) devices 714 that are usable by the computing devices. An example of an I/O device is a display screen that is available to display output from the computing devices. Other known I/O device may be used with the computing device as desired. Networking devices 716 and similar communication devices may be included in the computing device. The networking devices 716 may be wired or wireless networking devices that connect to the internet, a LAN, WAN, or other computing network.

The components or modules that are shown as being stored in the memory device 720 may be executed by the processor 712. The term “executable” may mean a program file that is in a form that may be executed by a processor 712. For example, a program in a higher-level language may be compiled into machine code in a format that may be loaded into a random-access portion of the memory device 720 and executed by the processor 712, or source code may be loaded by another executable program and interpreted to generate instructions in a random-access portion of the memory to be executed by a processor. The executable program may be stored in any portion or component of the memory device 720. For example, the memory device 720 may be random access memory (RAM), read only memory (ROM), flash memory, a solid-state drive, memory card, a hard drive, optical disk, floppy disk, magnetic tape, or any other memory components.

The processor 712 may represent multiple processors and the memory 720 may represent multiple memory units that operate in parallel to the processing circuits. This may provide parallel processing channels for the processes and data in the system. The local interface 718 may be used as a network to facilitate communication between any of the multiple processors and multiple memories. The local interface 718 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions and may even be distributed over several different code segments, among different programs and across several memory devices. Similarly, operational data may be identified and illustrated herein within modules and may be embodied in any suitable form and organized within any suitable type of data structure. The operational data may be collected as a single data set, or may be distributed over different locations including over different storage devices. The modules may be passive or active, including agents operable to perform desired functions.

The present technology disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

The present technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, a non-transitory machine readable storage medium, such as RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example and not limitation, communication media includes wired media such as a wired network or direct-wired connection and wireless media such as acoustic, radio frequency, infrared and other wireless media. The term computer readable media as used herein includes communication media.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A system for sending notes to user-folders using metadata tags, comprising:
at least one processor;
a memory device including instructions that, when executed by the at least one processor, cause the system to:
receive data messages from a plurality of user devices sent over a messaging network, wherein the data messages are addressed to a common messaging address, and the data messages contain at least a metadata tag and a note;
identify a user account associated with a source address of the data message;
analyze the data message to identify a metadata tag and a note contained in the data message, wherein the metadata tag indicates a user-folder to store the note; and
store the note in the user-folder associated with the user account.

2. The system in claim 1, wherein the source address of the data message is one of: a phone number of the user, a unique hardware identifier of the user device, internet protocol (IP) address, an email address, or an account number associated with the user.

3. The system in claim 1, wherein a hash symbol or asterisk prefaces a folder name in the metadata tag.

4. The system in claim 1, wherein the metadata tag indicates a beginning of the note in the data message, or the metadata tag indicates an end of the note in the data message.

5. The system in claim 1, wherein the instruction that analyzes the data message to identify the metadata tag further causes the system to:
analyze the data message to identify a first metadata tag that indicates a parent folder and a second metadata tag that indicates a child folder in which to store the note.

6. The system in claim 1, wherein the memory device further includes instructions that, when executed by the at least one processor, cause the system to:
receive a data object attached to the data message; and
store the data object in the user-folder.

7. The system in claim 1, wherein the memory device further includes instructions that, when executed by the at least one processor, cause the system to:
determine that the user-folder associated with the user account does not exist; and
create the user-folder associated with the user account, wherein the user-folder is assigned a name of the metadata tag.

8. The system as in claim 1, further comprising performing actions based on a type or contents of the metadata tag, note or attachments.

9. The system as in claim 8, wherein the actions are at least one of: creating an event associated with the note, sharing the note folder with other users, creating a sub-folder and storing the note in the sub-folder, generating a calendar event associated with the note, setting a reminder associated with the note, marking a task associated with the note as a priority, creating a social media post based on the note, and/or storing an attachment received with the note in the folder indicated by the metadata tag.

10. The system as in claim 1, wherein multiple note entries or tasks can be included in a note using a symbol to separate each entry or task in the note.

11. A computer implemented method for sending notes to user-folders using metadata tags, comprising:
receiving data messages from a plurality of user devices sent over a messaging network, wherein the data messages are addressed to a common telephone number that is associated with a note management system, and the data messages contain at least a metadata tag and a note;
identifying a user account associated with a source address of a data message in response to receiving the data message from a user device;
analyzing the data message to identify a metadata tag and a note contained in the data message, wherein the metadata tag indicates a user-folder to store the note; and
storing the note in the user-folder associated with the user account.

12. The method in claim 11, wherein the source address of the data message is one of: a phone number of the user, a unique hardware identifier of the user device, internet protocol (IP) address, email address, or an account number associated with the user.

13. The method in claim 11, wherein a hash symbol or asterisk prefaces a folder name in the metadata tag.

14. The method in claim 11, wherein the metadata tag indicates a beginning of the note in the data message, or the metadata tag indicates an end of the note in the data message.

15. The method in claim 11, wherein analyzing the data message to identify the metadata tag further comprises:
analyzing the data message to identify a first metadata tag that indicates a parent folder and a second metadata tag that indicates a child folder in which to store the note.

16. The method in claim 11, wherein the method further comprises:
receiving a data object attached to the data message; and
storing the data object in the user-folder.

17. The method in claim 11, further comprising:
determining that the user-folder associated with the user account does not exist; and
creating the user-folder associated with the user account, wherein the user-folder is assigned a name of the metadata tag.

18. A non-transitory machine readable storage medium including instructions embodied thereon for sending notes to user-folders using metadata tags, wherein the instructions, when executed by at least one processor:
receive data messages from a plurality of user devices sent over a messaging network, wherein the data messages are addressed to a common telephone number that is associated with a note management system, and the data messages contain at least a metadata tag and a note;
identify a user account associated with a source address of the data message;
analyze the data message to identify a metadata tag and a note contained in the data message, wherein the metadata tag indicates a user-folder to store the note; and
store the note in the user-folder associated with the user account.

19. The non-transitory machine readable storage medium in claim 18, wherein the source address of the data message is one of: a phone number of the user, a unique hardware identifier of the user device, internet protocol (IP) address, and email address, or an account number associated with the user.

20. The non-transitory machine readable storage medium in claim 18, wherein a hash symbol prefaces a folder name in the metadata tag.

21. The non-transitory machine readable storage medium in claim 18, wherein the metadata tag indicates a beginning of the note in the data message, or the metadata tag indicates an end of the note in the data message.
